(19) United States
(12) Patent Application Publication
(10) Pub. No.: US 2025/0131699 A1
(43) Pub. Date: Apr. 24, 2025

(54) Used Home Appliance Recognition Method Based On Multi-Source Data Fusion

(71) Applicant: Beijing University of Technology, Beijing (CN)

(72) Inventors: Honggui HAN, Beijing (CN); Xiaoye FAN, Beijing (CN); Fangyu LI, Beijing (CN)

(21) Appl. No.: 18/822,416

(22) Filed: Sep. 2, 2024

(30) Foreign Application Priority Data
Oct. 20, 2023 (CN) 202311370465.1

(51) Int. Cl. G06V 10/80; G06V 10/12; G06V 10/774; G06V 10/82; G06V 20/60

(52) U.S. Cl. CPC G06V 10/803; G06V 10/12; G06V 10/774; G06V 10/82; G06V 20/60; G06V 2201/06

(57) ABSTRACT

A method for identifying waste household appliances based on multi-source data fusion is applied to a waste household appliance dismantling plant. To accurately identify the class of waste household appliances and achieve effective dismantling, the patented technology of the invention utilizes a generative adversarial network model to obtain multi-source data, constructs a hierarchical multi-source data interaction model for multi-source data feature interaction, and establishes a multi-source data fusion model based on complementary networks. The method achieves complementary learning of multi-source data features and obtains discriminative features. The method achieves high-precision identification of waste household appliances in the process of waste household appliance recycling under different lighting conditions.

### CROSS-REFERENCE TO RELATED APPLICATION

This non-provisional patent application claims priority to Chinese Patent application, Ser. No. 202311370465.1, filed Oct. 20, 2023, the disclosures of which are incorporated herein in entirety.

### TECHNOLOGY AREA

The invention establishes a waste household appliance identification method based on multi-source data fusion, obtains multi-source data corresponding to RGB image by using the generative adversarial network, designs a multi-source data fusion model based on complementary network, realizes the accurate fusion of multi-source data, and completes the accurate classification of waste household appliance. This method, based on multi-source data fusion, can solve the problem of poor feature discrimination due to the change of lighting conditions and the loss of image details in the actual recycling of waste household appliances, achieve high-precision classification of waste household appliances, and provide technical support for the recycling industry of waste household appliances.

### TECHNOLOGY BACKGROUND

With the increasing production of urban waste household appliances and the deterioration of environmental conditions, the recycling of waste household appliance resources has become a challenging issue. Waste household appliance classification, as a key link in the recycling process, has become a focus of attention. Currently, manual classification is mainly used for waste household appliances, which is both cumbersome and inefficient, making it difficult to be widely promoted. Developing an intelligent and automated method for classifying household waste appliances is crucial to achieving current environmental resource recovery goals. Waste household appliance classification based on deep learning has effectively improved the level of automation in waste household appliance classification. However, in the actual classification process, due to the influence of lighting conditions on the acquisition of waste household appliance images, some detailed information is lost, resulting in low accuracy of waste household appliance classification results. Accurate classification of waste household appliances in practical application environments has significant economic and social benefits. Therefore, the research results of this invention have broad application prospects.

Traditional methods for waste household appliance classification have low accuracy and high costs. With the improvement of living standards in China, the amount of community waste household appliances is increasing. These traditional identification methods can no longer meet the daily needs of waste household appliance classification. To solve this complexity, some perception-based recycling identification methods have been proposed. Waste household appliances have various complex characteristics, and using a single sensor to obtain data results in limited types of waste household appliances that these methods can identify, limiting their applicability. With the development of machine learning, image-based deep recognition methods have been widely studied. The quality of the image affects the performance of the model. However, the lighting conditions during image capture affect the image quality. Low-light images can lead to missing image details, reducing the discriminability of extracted features. In recent years, image recognition methods based on multi-source data fusion have attracted widespread attention. These methods can enhance feature learning by combining complementary information features from multiple sources. However, how to conduct interactive learning of multi-source data in such methods is difficult, and unreasonable fusion can easily lead to learning redundant features. Therefore, how to fuse multi-source data to obtain discriminative features and achieve rapid and accurate classification of waste household appliances has become an important research topic in the field of waste household appliance recycling, with significant practical significance.

The invention proposes a waste household appliance identification method based on multi-source data fusion, achieving intelligent classification of waste household appliances. First, the generative adversarial network model is used to obtain multi-source data. Then, a hierarchical multi-source data interaction model is constructed to facilitate the interaction of features from multiple sources. Finally, a multi-source data fusion model based on complementary networks is established to achieve complementary learning of multi-source data features, thereby obtaining discriminative features and improving the accuracy of waste household appliance classification. This method can address the issue of missing details in low-light waste household appliance images, which leads to insufficient feature mining, and achieve high-precision waste household appliance classification in practical waste household appliance recycling processes. It provides an effective solution to the waste household appliance recycling and classification problem.

### SUMMARY OF THE PATENT

The present invention provides a waste household appliance identification method based on multi-source data fusion. The method utilizes a Generative Adversarial Network model to obtain multi-source data, constructs a hierarchical multi-source data interaction model for multi-source data feature interaction, and establishes a multi-source data fusion model based on complementary networks. It achieves complementary learning of multi-source features, obtains discriminative features, and improves the accuracy of waste household appliance classification. In practical waste household appliance recycling processes, the method can achieve high-precision waste household appliance classification even in low-light conditions where details in waste household appliance images are missing.

The present invention adopts the following technical solution and implementation steps:
1. A waste household appliance recognition method based on multi-source data fusion, comprising the following steps:
(1) collecting and preprocessing multi-source data of waste household appliances
   1) Basler acA1920-155 um industrial camera is used to capture images of waste household appliances transported on conveyor belts in a waste household appliance dismantling plant; images of waste household appliances are collected; the dataset comprises five classes: refrigerator, washing machine, air conditioner, television, and computer; totaling Z RGB images;
   2) the Cat5e network cable is used to connect the Ethernet interface of the industrial camera to one Ethernet interface of the Cisco Catalyst 2960 switch; VLAN is configured and QoS is enabled on the switch port to facilitate the data stream transmission from the camera; the Dell PowerEdge server interface is connected to another Ethernet interface on the switch; the server is configured to receive and process the image data transmitted by the camera based on the HTTP communication protocol between the camera and the server; the server utilizes the Linux operating system and the PyTorch deep learning framework to construct the generative adversarial network model; the model converts RGB images into corresponding thermal and depth images; the RGB images, thermal images, and depth images are stored in the Seagate BarraCuda 4 TB internal hard disk drive connected to the server, forming the multi-source image dataset of waste household appliances; the learning process of constructing a generative adversarial network model in the server to obtain multi-source data is as follows:
obtaining thermal image data: a generative adversarial network model based on the MFNet dataset is trained; the MFNet dataset consists of Z₁ pairs of RGB images and thermal images for model training; the generative adversarial network model consists of a generator G and a discriminator D; the generator includes four layers: the first and second layers are convolutional layers with 3×3 kernels and a stride of 2, with 64and 128 kernels, respectively; the third layer is a deconvolutional layer with a 3×3 kernel, a stride of 2, and 64 kernels; the fourth layer is the output layer with a 3×3 kernel, a stride of 2, and 1 kernel; the discriminator includes four layers: the first and second layers are convolutional layers with 3x3 kernels and a stride of 2, with 64 and 128 kernels, respectively, the third layer is a fully connected layer with 256 neurons, and the fourth layer is the output layer with 1 neuron; the loss function for the generative adversarial network is:

$${min}_{G} {max}_{D} = E [ log D ( U ) ] + E [ log D ( G ( M ) ) ] \qquad ( 1 )$$

where M represents the RGB images, U represents the generated images, E represents the expectation operator, G represents the data generator, and D represents the data discriminator; the generative adversarial network model is trained according to the loss function; the waste household appliances' RGB images is sent as the input into the trained model to obtain waste household appliances' thermal image data;
obtaining depth image data: based on the MiDaS dataset, a generative adversarial network model is trained; the MiDaS dataset includes pairs of RGB images and depth images for model training; the model is trained using the loss function shown in equation (1); to obtain depth image data for waste household appliances, the RGB images of the waste household appliances are input into the trained model;
   3) the pixel of each image in the multi-source image dataset of waste household appliances is normalized to [0, 1]; the normalized multi-source image dataset of waste homes is divided into two groups; one group is training images, including P RGB images, and the corresponding P thermal images and P depth images; the other group is test images, including Q RGB images, and their corresponding Q thermal images and Q depth images;
(2) constructing the hierarchical multi-source data interaction model
in the server, a hierarchical multi-source data interaction model is constructed: the model consists of 5 modules, which are HMSI-c, c=1, 2, 3, 4, 5; VGG-16 model is used to extract multi-source image features; F_{c}^{R} represents the RGB image features extracted from the module c, F_{c}^{T} represents the thermal image features extracted from the module c, and F_{c}^{D} represents the depth image features extracted from the module c; C_{A}(⋅) represents the formula for calculating the channel attention mechanism:

$${C}_{A} ( \cdot ) = {F}_{C}^{σ} ( {F}_{C}^{φ} ( {M}_{s} ( \cdot ) ) ) \qquad ( 2 )$$

where F_{c}^{σ}(⋅) is a fully connected layer with Sigmoid activation function, F_{c}^{φ}(⋅) is a fully connected layer with ReLU activation function, Mₛ(⋅) represents global maximum pooling, and Sigmoid activation function σ(⋅) is:

$$σ ( x ) = \frac{1}{1 + 2.7 {1}^{( - x )}} \qquad ( 3 )$$

where x represents the eigenvalue of the input and the ReLU activation function r(⋅) is:

$$r ( x ) = \{ \begin{matrix}x & x > 0 \\ 0 & x \leq 0\end{matrix} \qquad ( 4 )$$

S_{A}(⋅) represents the spatial attention mechanism calculation formula:

$${S}_{A} ( \cdot ) = {z}_{σ} ( {M}_{s} ( \cdot ) ) \qquad ( 5 )$$

where z_{σ}(⋅) represents the convolution layer with the Sigmoid activation function;
channel attention mechanism and spatial attention mechanism are applied to RGB image features respectively, and then spatial attention mechanism is applied to thermal image and depth image features, which obtains multi-source data interaction features; the output feature O₁ of the HMSI-1 is as follows:

$${O}_{1} = [ {C}_{A} ( {S}_{A} ( {C}_{A} ( {F}_{1}^{R} ) ⊙ {F}_{1}^{R} ) ⊗ {F}_{1}^{R} ⊗ ( {S}_{A} ( {F}_{1}^{T} ) ) ⊗ ( {S}_{A} ( {F}_{1}^{D} ) ) ) ] ⊙ [ {S}_{A} ( {C}_{A} ( {F}_{1}^{R} ) ⊙ {F}_{1}^{R} ) ⊗ {F}_{1}^{R} ] \qquad ( 6 )$$

where ⊙ represents channel multiplication and ⊗ represents element multiplication;
the output of the HMSI-c (c≠1) is:

$${O}_{c} = [ {C}_{A} ( {S}_{A} ( {C}_{A} ( {F}_{c}^{R} ) ⊙ {F}_{c}^{R} ) ⊗ {F}_{c}^{R} ⊗ ( {S}_{A} ( {F}_{c}^{T} ) ) ⊗ ( {S}_{A} ( {F}_{c}^{D} ) ) ) ] ⊙ {O}_{c - 1} \qquad ( 7 )$$

where O_{c} is the multi-source data interaction feature;
(3) establishing the multi-source data fusion model based on the complementary network
each image sample contains a pair of positive sample features, namely the RGB image feature F₅^{R} extracted from the HMSI-5 module and the multi-source data interaction feature O₅ output from the HMSI-5 module; the number of training samples is P, and the sample contains 2 P sample features; if one sample is selected as the positive sample feature, the other (2 P-2) sample features in the small-batch sample are regarded as the negative sample feature; positive and negative sample feature similarity are calculated based on cosine similarity, and the formula for calculating cosine similarity is as follows:

$$s ( v , w ) = \frac{{v}^{T} w}{‖ v ‖ \cdot ‖ w ‖} \qquad ( 8 )$$

where s is the cosine; v and w are the eigenvectors; T stands for transpose, ∥⋅∥ is the module of the vector; ⋅ stands for multiplication;
the cross-entropy loss function L of the multi-source data fusion model based on complementary networks is expressed as:

$$L = - \frac{1}{6700} {\sum }_{i = 1}^{6700} y ( i ) log \frac{{2.71}^{( s ( {F}_{5}^{R} ( i ) , {O}_{5} ( i ) ) / 0.05 )}}{{\sum }_{k = 1}^{6700} {ℕ}_{[ k \neq i ]} {2.71}^{( s ( {F}_{5}^{R} ( i ) , {O}_{5} ( k ) ) / 0.05 )}} \qquad ( 9 )$$

where y(i) is the class label of the i th sample feature, i=1, 2, . . . , 2 P, k represents the k th sample feature in the training sample feature, k=1, 2, . . . , 2 P; F₅^{R}(i) is the RGB image feature of the i th sample in the HMSI-5 module, O₅(i) is the multi-source data interaction feature of the i sample output in HMSI-5 module, and O₅(k) is the multi-source data interaction feature of the k th sample output in the HMSI-5 module; [symbol] _{[k≠i]} ∈{0,1}, if k≠i, the value is 1, otherwise 0; according to the loss function, the multi-source data fusion model is trained; the number of training iterations of the multi-source data fusion model is set to 200, and the hyperparameters of the model during the training are recorded; after the training reaches the number of iterations, the training is terminated, and the weight parameters of the last training are saved to complete the model training;
(4) recognizing the waste household appliances
after model training, the model files are transferred from the server to the Dell computer at the dismantling plant control center using the FTP protocol; the computer is equipped with an NVIDIA Geforce RTX 2080 Ti GPU, which is used for parallel computing to recognize images of 5 classes of waste household appliances, obtaining the predicted class label y(j) for each sample of waste household appliances in the images, where j=1, 2, . . . , Q; the identification results are then displayed on the computer monitor, completing the waste household appliance identification task.

The novelties of this patent contain:
(1) The present invention utilizes a Generative Adversarial Network (GAN) model to obtain multi-source data, and the acquisition of depth images and thermal images does not depend on specific devices, thereby reducing the cost of data acquisition. Additionally, it avoids the difficulty of meeting data collection requirements in various scenarios due to restrictions on sensor installation conditions.
(2) The present invention proposes a multi-source data fusion model based on complementary networks, which enhances the feature learning capability of low-light images by complementing multi-source data information. It can obtain more effective features under different photographing conditions, enhance its applicability in practical applications, and provide technical support for the waste household appliance recycling industry.

### DESCRIPTION OF DRAWINGS

FIG. 1 is the classification performance of the multi-source data fusion classification method for waste household appliances under different hyperparameters in the present invention.

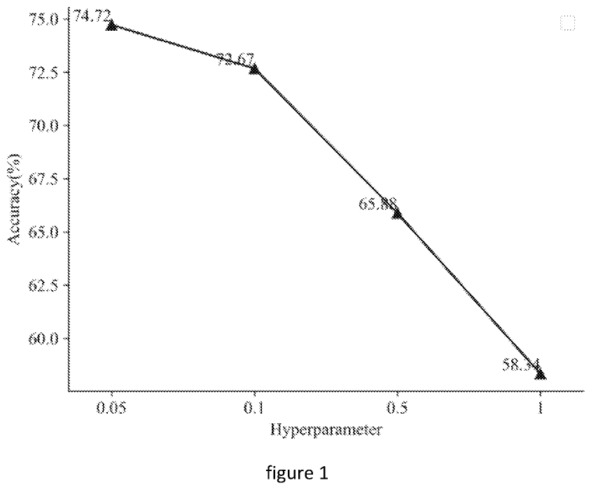

### DETAILED DESCRIPTION OF THE INVENTION

1. A waste household appliance recognition method based on multi-source data fusion, comprising the following steps:
(1) collecting and preprocessing multi-source data of waste household appliances
   1) Basler acA1920-155 um industrial camera is used to capture images of waste household appliances transported on conveyor belts in a waste household appliance dismantling plant; images of waste household appliances are collected; the dataset comprises five classes: refrigerator, washing machine, air conditioner, television, and computer; totaling Z RGB images;
   2) the Cat5e network cable is used to connect the Ethernet interface of the industrial camera to one Ethernet interface of the Cisco Catalyst 2960 switch; VLAN is configured and QoS is enabled on the switch port to facilitate the data stream transmission from the camera; the Dell PowerEdge server interface is connected to another Ethernet interface on the switch; the server is configured to receive and process the image data transmitted by the camera based on the HTTP communication protocol between the camera and the server; the server utilizes the Linux operating system and the PyTorch deep learning framework to construct the generative adversarial network model; the model converts RGB images into corresponding thermal and depth images; the RGB images, thermal images, and depth images are stored in the Seagate BarraCuda 4 TB internal hard disk drive connected to the server, forming the multi-source image dataset of waste household appliances; the learning process of constructing a generative adversarial network model in the server to obtain multi-source data is as follows:
obtaining thermal image data: a generative adversarial network model based on the MFNet dataset is trained; the MFNet dataset consists of Z₁ pairs of RGB images and thermal images for model training; the generative adversarial network model consists of a generator G and a discriminator D; the generator includes four layers: the first and second layers are convolutional layers with 3×3 kernels and a stride of 2, with 64 and 128 kernels, respectively; the third layer is a deconvolutional layer with a 3×3 kernel, a stride of 2, and 64 kernels; the fourth layer is the output layer with a 3×3 kernel, a stride of 2, and 1 kernel; the discriminator includes four layers: the first and second layers are convolutional layers with 3×3 kernels and a stride of 2, with 64 and 128 kernels, respectively, the third layer is a fully connected layer with 256 neurons, and the fourth layer is the output layer with 1 neuron; the loss function for the generative adversarial network is:

$${min}_{G} {max}_{D} = E [ log D ( U ) ] + E [ log D ( G ( M ) ) ] \qquad ( 1 )$$

where M represents the RGB images, U represents the generated images, E represents the expectation operator, G represents the data generator, and D represents the data discriminator; the generative adversarial network model is trained according to the loss function; the waste household appliances' RGB images is sent as the input into the trained model to obtain waste household appliances' thermal image data;
obtaining depth image data: based on the MiDaS dataset, a generative adversarial network model is trained; the MiDaS dataset includes pairs of RGB images and depth images for model training; the model is trained using the loss function shown in equation (1); to obtain depth image data for waste household appliances, the RGB images of the waste household appliances are input into the trained model;
   3) the pixel of each image in the multi-source image dataset of waste household appliances is normalized to [0, 1]; the normalized multi-source image dataset of waste homes is divided into two groups; one group is training images, including P RGB images, and the corresponding P thermal images and P depth images; the other group is test images, including Q RGB images, and their corresponding Q thermal images and Q depth images;
(2) constructing the hierarchical multi-source data interaction model
in the server, a hierarchical multi-source data interaction model is constructed: the model consists of 5 modules, which are HMSI-c, c=1, 2, 3, 4, 5; VGG-16 model is used to extract multi-source image features; F_{c}^{R} represents the RGB image features extracted from the module c, F_{c}^{T} represents the thermal image features extracted from the module c, and F_{c}^{D} represents the depth image features extracted from the module c; C_{A}(⋅) represents the formula for calculating the channel attention mechanism:

$${C}_{A} ( \cdot ) = {F}_{C}^{σ} ( {F}_{C}^{φ} ( {M}_{s} ( \cdot ) ) ) \qquad ( 2 )$$

where F_{c}^{σ}(⋅) is a fully connected layer with Sigmoid activation function, F_{c}^{φ}(⋅) is a fully connected layer with ReLU activation function, Mₛ(⋅) represents global maximum pooling, and Sigmoid activation function σ(⋅) is:

$$σ ( x ) = \frac{1}{1 + 2.7 {1}^{( - x )}} \qquad ( 3 )$$

where x represents the eigenvalue of the input and the ReLU activation function r(⋅) is:

$$r ( x ) = \{ \begin{matrix}x & x > 0 \\ 0 & x \leq 0\end{matrix} \qquad ( 4 )$$

S_{A}(⋅) represents the spatial attention mechanism calculation formula:

$${S}_{A} ( \cdot ) = {z}_{σ} ( {M}_{s} ( \cdot ) ) \qquad ( 5 )$$

where z_{σ}(⋅) represents the convolution layer with the Sigmoid activation channel attention mechanism and spatial attention mechanism are applied to RGB image features respectively, and then spatial attention mechanism is applied to thermal image and depth image features, which obtains multi-source data interaction features; the output feature O₁ of the HMSI-1 is as follows:

$${O}_{1} = [ {C}_{A} ( {S}_{A} ( {C}_{A} ( {F}_{1}^{R} ) ⊙ {F}_{1}^{R} ) ⊗ {F}_{1}^{R} ⊗ \qquad ( 6 )$$

$$( {S}_{A} ( {F}_{1}^{T} ) ) ⊗ ( {S}_{A} ( {F}_{1}^{D} ) ) ) ] ⊙ [ {S}_{A} ( {C}_{A} ( {F}_{1}^{R} ) ⊙ {F}_{1}^{R} ) ⊗ {F}_{1}^{R} ]$$

where ⊙ represents channel multiplication and ⊗ represents element multiplication;
the output of the HMSI-c (c≠1) is:

$${O}_{c} = [ {C}_{A} ( {S}_{A} ( {C}_{A} ( {F}_{c}^{R} ) ⊙ {F}_{c}^{R} ) ⊗ {F}_{c}^{R} ⊗ ( {S}_{A} ( {F}_{c}^{T} ) ) ⊗ ( {S}_{A} ( {F}_{c}^{D} ) ) ) ] ⊙ {O}_{c - 1} \qquad ( 7 )$$

where O_{c} is the multi-source data interaction feature;
(3) establishing the multi-source data fusion model based on the complementary network
each image sample contains a pair of positive sample features, namely the RGB image feature F₅^{R} extracted from the HMSI-5 module and the multi-source data interaction feature O₅ output from the HMSI-5 module; the number of training samples is P, and the sample contains 2 P sample features; if one sample is selected as the positive sample feature, the other (2 P-2) sample features in the small-batch sample are regarded as the are calculated based on cosine similarity, and the formula for calculating cosine similarity is as follows:

$$s ( v , w ) = \frac{{v}^{T} w}{‖ v ‖ \cdot ‖ w ‖} \qquad ( 8 )$$

where s is the cosine; v and w are the eigenvectors; T stands for transpose, ∥⋅∥ is the module of the vector; ⋅ stands for multiplication;
the cross-entropy loss function L of the multi-source data fusion model based on complementary networks is expressed as:

$$L = - \frac{1}{6700} {\sum }_{i = 1}^{6700} y ( i ) log \frac{{2.71}^{( s ( {F}_{5}^{R} ( i ) , {O}_{5} ( i ) ) / 0.05 )}}{{\sum }_{k = 1}^{6700} {ℕ}_{[ k \neq i ]} {2.71}^{( s ( {F}_{5}^{R} ( i ) , {O}_{5} ( k ) ) / 0.05 )}} \qquad ( 9 )$$

where y(i) is the class label of the i th sample feature, i=1, 2, . . . , 2 P, k represents the k th sample feature in the training sample feature, k=1, 2, . . . , 2 P; F₅^{R}(i) is the RGB image feature of the i th sample in the HMSI-5 module, O₅(i) is the multi-source data interaction feature of the i sample output in HMSI-5 module, and O₅(k) is the multi-source data interaction feature of the k th sample output in the HMSI-5 module; [symbol] _{[k≠i]} ∈{0,1}, if k≠i, the value is 1, otherwise 0; according to the loss function, the multi-source data fusion model is trained; the number of training iterations of the multi-source data fusion model is set to 200, and the hyperparameters of the model during the training are recorded; after the training reaches the number of iterations, the training is terminated, and the weight parameters of the last training are saved to complete the model training;
(4) recognizing the waste household appliances
after model training, the model files are transferred from the server to the Dell computer at the dismantling plant control center using the FTP protocol; the computer is equipped with an NVIDIA Geforce RTX 2080 Ti GPU, which is used for parallel computing to recognize images of 5 classes of waste household appliances, obtaining the predicted class label y(j) for each sample of waste household appliances in the images, where j=1, 2, . . . , Q; the identification results are then displayed on the computer monitor, completing the waste household appliance identification task.

What is claimed is:

1. A waste household appliance recognition method based on multi-source data fusion, comprising the following steps:
(1) collecting and preprocessing multi-source data of waste household appliances
1) Basler acA1920-155 um industrial camera is used to capture images of waste household appliances transported on conveyor belts in a waste household appliance dismantling plant; images of waste household appliances are collected; the dataset comprises five classes: refrigerator, washing machine, air conditioner, television, and computer; totaling Z RGB images;
2) the Cat5e network cable is used to connect the Ethernet interface of the industrial camera to one Ethernet interface of the Cisco Catalyst 2960 switch; VLAN is configured and QoS is enabled on the switch port to facilitate the data stream transmission from the camera; the Dell PowerEdge server interface is connected to another Ethernet interface on the switch; the server is configured to receive and process the image data transmitted by the camera based on the HTTP communication protocol between the camera and the server; the server utilizes the Linux operating system and the PyTorch deep learning framework to construct the generative adversarial network model; the model converts RGB images into corresponding thermal and depth images; the RGB images, thermal images, and depth images are stored in the Seagate BarraCuda 4 TB internal hard disk drive connected to the server, forming the multi-source image dataset of waste household appliances; the learning process of constructing a generative adversarial network model in the server to obtain multi-source data is as follows:
obtaining thermal image data: a generative adversarial network model based on the MFNet dataset is trained; the MFNet dataset consists of Z₁ pairs of RGB images and thermal images for model training; the generative adversarial network model consists of a generator G and a discriminator D; the generator includes four layers: the first and second layers are convolutional layers with 3×3 kernels and a stride of 2, with 64 and 128 kernels, respectively; the third layer is a deconvolutional layer with a 3×3 kernel, a stride of 2, and 64 kernels; the fourth layer is the output layer with a 3×3 kernel, a stride of 2, and 1 kernel; the discriminator includes four layers: the first and second layers are convolutional layers with 3×3 kernels and a stride of 2, with 64 and 128 kernels, respectively, the third layer is a fully connected layer with 256neurons, and the fourth layer is the output layer with 1 neuron; the loss function for the generative adversarial network is:
$${min}_{G} {max}_{D} = E [ log D ( U ) ] + E [ log D ( G ( M ) ) ] \qquad ( 1 )$$
where M represents the RGB images, U represents the generated images, E represents the expectation operator, G represents the data generator, and D represents the data discriminator; the generative adversarial network model is trained according to the loss function; the waste household appliances' RGB images is sent as the input into the trained model to obtain waste household appliances' thermal image data;
obtaining depth image data: based on the MiDaS dataset, a generative adversarial network model is trained; the MiDaS dataset includes pairs of RGB images and depth images for model training; the model is trained using the loss function shown in equation (1); to obtain depth image data for waste household appliances, the RGB images of the waste household appliances are input into the trained model;
3) the pixel of each image in the multi-source image dataset of waste household appliances is normalized to [0, 1]; the normalized multi-source image dataset of waste homes is divided into two groups; one group is training images, including P RGB images, and the corresponding P thermal images and P depth images; the other group is test images, including Q RGB images, and their corresponding Q thermal images and Q depth images;
(2) constructing the hierarchical multi-source data interaction model
in the server, a hierarchical multi-source data interaction model is constructed: the model consists of 5 modules, which are HMSI-c, c=1, 2, 3, 4, 5; VGG-16 model is used to extract multi-source image features; F_{c}^{R} represents the RGB image features extracted from the module c, F_{c}^{T} represents the thermal image features extracted from the module c, and F_{c}^{D} represents the depth image features extracted from the module c; C_{A}(⋅) represents the formula for calculating the channel attention mechanism:
$${C}_{A} ( \cdot ) = {F}_{C}^{σ} ( {F}_{C}^{φ} ( {M}_{s} ( \cdot ) ) ) \qquad ( 2 )$$
where F_{c}^{σ}(⋅) is a fully connected layer with Sigmoid activation function, F_{c}^{φ}(⋅) is a fully connected layer with ReLU activation function, Mₛ(⋅) represents global maximum pooling, and Sigmoid activation function σ(⋅) is:
$$σ ( x ) = \frac{1}{1 + {2.71}^{( - x )}} \qquad ( 3 )$$
where x represents the eigenvalue of the input and the ReLU activation function r(⋅) is:
$$r ( x ) = \{ \begin{matrix}x & x > 0 \\ 0 & x \leq 0\end{matrix} \qquad ( 4 )$$
S_{A}(⋅) represents the spatial attention mechanism calculation formula:
$${S}_{A} ( \cdot ) = {z}_{σ} ( {M}_{s} ( \cdot ) ) \qquad ( 5 )$$
where Z_{σ}(⋅) represents the convolution layer with the Sigmoid activation function;
channel attention mechanism and spatial attention mechanism are applied to RGB image features respectively, and then spatial attention mechanism is applied to thermal image and depth image features, which obtains multi-source data interaction features; the output feature O₁ of the HMSI-1 is as follows:
$${O}_{1} = [ {C}_{A} ( {S}_{A} ( {C}_{A} ( {F}_{1}^{R} ) ⊙ {F}_{1}^{R} ) ⊗ \qquad ( 6 )$$
$${F}_{1}^{R} ⊗ ( {S}_{A} ( {F}_{1}^{T} ) ) ⊗ ( {S}_{A} ( {F}_{1}^{D} ) ) ) ] ⊙ [ {S}_{A} ( {C}_{A} ( {F}_{1}^{R} ) ⊙ {F}_{1}^{R} ) ⊗ {F}_{1}^{R} ]$$
where ⊙ represents channel multiplication and ⊗ represents element multiplication;
the output of the HMSI-c (c≠1) is:
$${O}_{c} = [ {C}_{A} ( {S}_{A} ( {C}_{A} ( {F}_{c}^{R} ) ⊙ {F}_{c}^{R} ) ⊗ {F}_{c}^{R} ⊗ ( {S}_{A} ( {F}_{c}^{T} ) ) ⊗ ( {S}_{A} ( {F}_{c}^{D} ) ) ) ] ⊙ {O}_{c - 1} \qquad ( 7 )$$
where O_{c} is the multi-source data interaction feature;
(3) establishing the multi-source data fusion model based on the complementary network
each image sample contains a pair of positive sample features, namely the RGB image feature F₅^{R} extracted from the HMSI-5 module and the multi-source data interaction feature O₅ output from the HMSI-5 module; the number of training samples is P, and the sample contains 2 P sample features; if one sample is selected as the positive sample feature, the other (2 P-2) sample features in the small-batch sample are regarded as the negative sample feature; positive and negative sample feature similarity are calculated based on cosine similarity, and the formula for calculating cosine similarity is as follows:
$$s ( v , w ) = \frac{{v}^{T} w}{‖ v ‖ \cdot ‖ w ‖} \qquad ( 8 )$$
where s is the cosine; v and w are the eigenvectors; T stands for transpose, ∥⋅∥ is the module of the vector; ⋅ stands for multiplication;
the cross-entropy loss function L of the multi-source data fusion model based on complementary networks is expressed as:
$$L = - \frac{1}{6700} {\sum }_{i = 1}^{6700} y ( i ) log \frac{{2.71}^{( s ( {F}_{5}^{R} ( i ) , {O}_{5} ( i ) ) / 0.05 )}}{{\sum }_{k = 1}^{6700} {ℕ}_{[ k \neq i ]} {2.71}^{( s ( {F}_{5}^{R} ( i ) , {O}_{5} ( k ) ) / 0.05 )}} \qquad ( 9 )$$
where y(i) is the class label of the i th sample feature, i=1, 2, . . . , 2 P, k represents the k th sample feature in the training sample feature, k=1, 2, . . . , 2 P; F₅^{R}(i) is the RGB image feature of the i th sample in the HMSI-5 module, O₅(i) is the multi-source data interaction feature of the i sample output in HMSI-5 module, and O₅(k) is the multi-source data interaction feature of the k th sample output in the HMSI-5 module; [symbol] _{[k≠i]} ∈{0,1}, if k≠i, the value is 1, otherwise 0; according to the loss function, the multi-source data fusion model is trained; the number of training iterations of the multi-source data fusion model is set to 200, and the hyperparameters of the model during the training are recorded; after the training reaches the number of iterations, the training is terminated, and the weight parameters of the last training are saved to complete the model training;
(4) recognizing the waste household appliances
after model training, the model files are transferred from the server to the Dell computer at the dismantling plant control center using the FTP protocol; the computer is equipped with an NVIDIA Geforce RTX 2080 Ti GPU, which is used for parallel computing to recognize images of 5 classes of waste household appliances, obtaining the predicted class label y(j) for each sample of waste household appliances in the images, where j=1, 2, . . . , Q; the identification results are then displayed on the computer monitor, completing the waste household appliance identification task.
